(19) United States
(12) Patent Application Publication
(10) Pub. No.: US 2006/0019640 A1
(43) Pub. Date: Jan. 26, 2006

(54) Smart redial method for mobile phones

(75) Inventors: Cheng-Shing Lai, Taipei Hsien (TW); Wan-Jun Liu, Nanking (CN)

Correspondence Address: BACON & THOMAS, PLLC, 625 SLATERS LANE, FOURTH FLOOR, ALEXANDRIA, VA, 22314, US

(73) Assignee: Inventec Appliances Corporation, Taipei Hsien (TW)

(21) Appl. No.: 10/893,946

(22) Filed: Jul. 20, 2004

(51) Int. Cl. H04Q 7/20; H04M 1/00; H04B 1/38

(52) U.S. Cl. 455/414.1; 455/564

(57) ABSTRACT

The present invention discloses a smart redial method for mobile phones capable of saving several sets of phone numbers of different contact persons in a phone book function of a mobile phone, so that when a user dials one of the telephone number of a contact person in the phone book through a user interface (UI), an auto-redial control program installed in the mobile phone will automatically display other sets of phone numbers of the same contact person for the user to redial automatically until the call is connected successfully, which effectively solves the problem of repeatedly search for other sets of phone numbers in the phone book to redial the call.

### BACKGROUND OF THE INVENTION

1. Field of the Invention

The present invention relates to a redial method, more particularly to a smart dial method for mobile phones capable of saving several sets of phone numbers of different contact persons in a phone book function of a mobile phone, so that when a user dials one of the telephone number of a contact person in the phone book through a user interface (UI), an auto-redial control program installed in the mobile phone will automatically display other sets of phone numbers of the same contact person for the user to redial automatically until the call is connected successfully.

2. Description of the Related Art

As telecommunication network technology advances, mobile phones (also known as handsets) feature a compact size, a comprehensive function and a decreasing price. Thus more and more people love to use mobile phones, and mobile phones have become one of the most popular telecommunication tools. Users can communicate with their friends or business associates through a mobile phone promptly, and mobile phones have the advantages of providing users a more convenient and faster way of communications than the traditional city phones.

Further, every second counts in the present fast-pace metropolitan lifestyle, and mobile phones can serve as a fast and convenient communication tool that comes with software such as games, a phone book, a voice mail, and an alarm clock, etc to provide additional services to users, and thus effectively enhancing the applications of mobile phones and satisfying the all-in-one requirements.

In general, the data in a phone book of the present mobile phone is entered or edited through the press keys on the mobile phone, so that users can save the commonly used phone numbers in the phone book and such arrangement facilitates users to make a call later. However, the press keys on the present mobile phone are not only few in quantity but is also small in size, so that the mobile phone can only use a press key to define several symbols or letters, which makes the data entry complicated and troublesome. Particularly for a mobile phone capable of logging on a network, users usually want to enter data in different fonts, which makes the entry more inconvenient.

Further, if a user dials a phone call once but fails to make the contact, the user usually saves the trouble of going back to the phone number and using an auto-redial function to redial the call. However, the redialed phone number is limited to the number previously dialed, and users generally have many phone numbers (since it is very common for a mobile phone to have two SIM cards or one SIM card with two phone numbers). If a user dials one of the phone numbers of an opposite party but fails to make the contact, then the user usually reopens the phone book function to search and record another phone number of the opposite party and then dials that number. Such repeated operation is complicated and troublesome, and thus the auto-redial function of the traditional mobile phone of the receiving party which concurrently have several contact phone numbers cannot contact the opposite party by searching another number automatically for the redial, and such design seems to be inconsiderate.

If there is a design that can effectively overcome the foregoing shortcomings and provides a smart choice of phone numbers for the redial, it is what users long for. Such design also improves the competitiveness among the products of the same sort.

### SUMMARY OF THE INVENTION

With the previous profound introduction of the prior art, it is not difficult for us to see that if a mobile phone cannot be dialed successfully for the first time, the previously dialed number is redialed, such mobile phone cannot dial another number of the receiving party, which is a major drawback of the traditional mobile phones. In view of the actual requirements of the market and users, the inventor of the present invention based on years of experience in the related industry to conduct extensive researches and experiments, and finally developed a smart redial method for mobile phones. Such ingenious idea of the invention is definitely a great contribution to the society.

The primary objective of the present invention is to design a mobile phone incorporating a smart redial method for redialing different sets of phone numbers, until the call is connected successfully and having the feature of facilitating users to search for several different phone numbers of the receiving party.

The above and other objects, features and advantages of the present invention will become apparent from the following detailed description taken with the accompanying drawings.

### BRIEF DESCRIPTION OF THE DRAWINGS

FIG. 1 is a flow chart of users selecting the auto-redial function according to the present invention.

FIG. 2 is a flow chart of the control program for users to select and automatically redial from different sets of phone number according to the present invention.

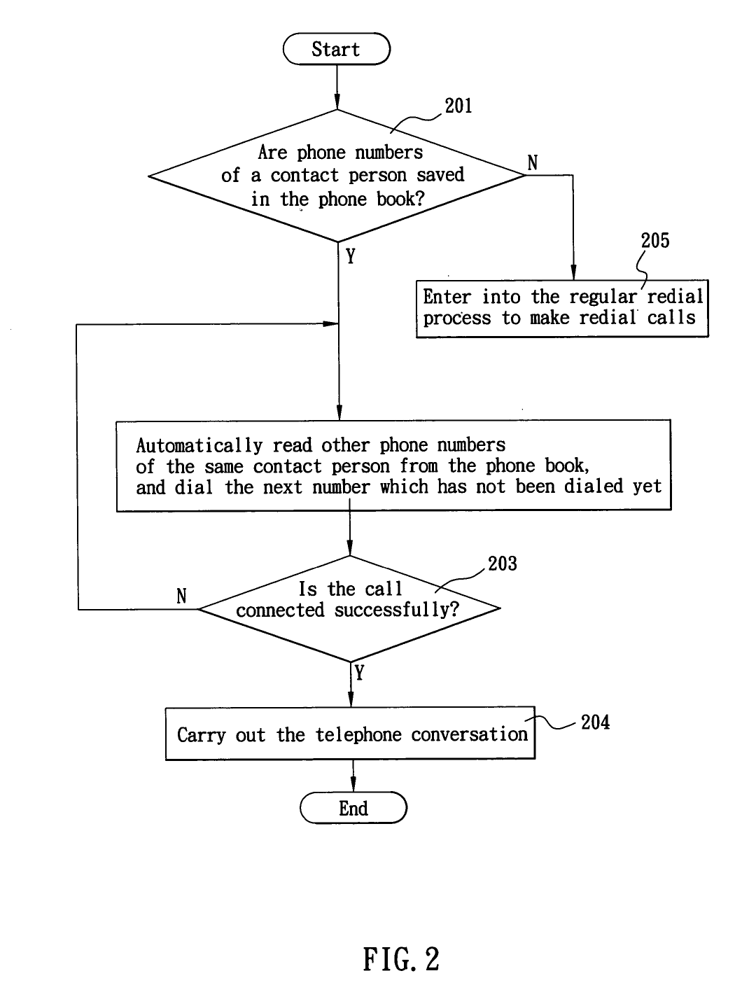

### DETAILED DESCRIPTION OF THE PREFERRED EMBODIMENTS

The present invention discloses a smart redial method for mobile phones, and such method capable of saving several sets of phone numbers of different contact persons in a phone book function of a mobile phone, so that when a user dials one of the telephone number of a contact person in the phone book through a user interface (UI), an auto-redial control program installed in the mobile phone will automatically display other sets of phone numbers of the same contact person for the user to redial automatically. Alternatively, the control program installed in the mobile phone for redialing other set of phone numbers of the same contact person conducts such redial until the call is connected successfully. Such arrangement achieves the smart-redial objective and effectively solves the problem of repeatedly search for other sets of phone numbers in the phone book to redial the call.

The phone book according to the invention provides users a space to save several different sets of phone numbers of several contact persons, and the auto-redial control program displays other sets of phone numbers of the contact persons on the mobile phone.

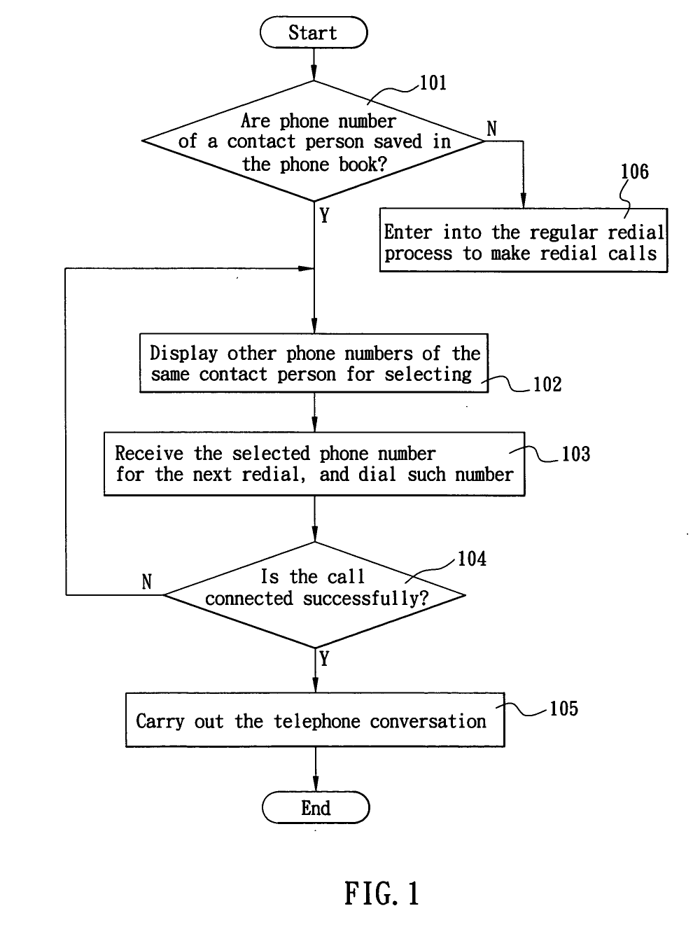

The method of carrying out the smart redial according to the present invention is described below. Please refer to FIG. 1. If a user dials one of the numbers of a contact person on the phone book, but the call cannot be connected successfully, and the user has selected an auto-redial function, then the auto-redial control program will go through the following steps:

Step (101): Check whether or not the phone book has such contact person and several related phone numbers; if yes, go to Step (102); if no, go to Step (106).

Step (102): Display another phone number of the contact person on the display screen for the user to choose.

Step (103): Receive the next redial number selected by the user, and dial such number (by that time, there is no need for the user to go back to the phone book to select a number).

Step (104): Determine whether or not the selected number can be dialed successfully; if yes, go to Step (105); if no, go to Step (102).

Step (105): Carry out the telephone conversation, and end the procedure.

Step (106): Indicate the contact person only having one phone number, and also enter into the regular redial process to make calls and or redial calls.

Further, if a user dials one of the numbers of a contact person listed on the phone book, but the call cannot be connected successfully, and the user has selected to use a control program to process several sets of phone numbers in the mobile phone, then the auto-redial function will go through the following steps:

Step (201): Check whether or not the phone book has such contact person and several related phone numbers; if yes, go to Step (202); if no, go to Step (206).

Step (202): Read other phone numbers of the same contact person from the phone book, and automatically dial the number which has not been dialed yet.

Step (203): Determine whether or not the selected phone number can be dialed successfully; if yes, go to Step (204); if no, go to Step (202).

Step (204): Carry out the telephone conversation, and end the procedure.

Step (205): Indicate the contact person only having one phone number, and also enter into the regular redial process to make calls and or redial calls.

From the above description, it is clear that the control program for processing several sets of phone numbers for the redial is used to automatically redial other sets of phone numbers of the same contact person until the call is made successfully or all related numbers have been dialed once. The invention definitely achieves the objective of a smart redial, and the design of the invention can effectively overcome the shortcomings of the prior art. Such design is definitely a humanistic design.

While the invention has been described by means of specific embodiments, numerous modifications and variations could be made thereto by those skilled in the art without departing from the scope and spirit of the invention set forth in the claims.

What is claimed is:

1. A smart redial method for a mobile phone, which has a plurality of phone numbers of a plurality of contact persons being saved into a phone book thereof, so that if a user dials a number of a contact person listed in said phone book and is unable to call said phone call, then an auto-redial control program installed in said mobile phone proceeds the steps of:
displaying other phone numbers of said contact person for said user to choose for a redial;
alternatively processing a redial from said plurality of phone numbers saved in said phone book;
alternatively or automatically dialing said other phone numbers of said contact person until one of said phone calls is connected successfully.

2. The smart redial method for mobile phones of claim 1, wherein said phone book provides users a space for saving a plurality of phone numbers of a plurality of contact persons, and said auto-redial control program automatically displays all of said other phone numbers of said contact person on a display screen.

3. The smart redial method for mobile phones of claim 2, wherein said auto-redial control program further comprises the steps of:
checking whether said contact person and said plurality of phone numbers of said contact person are in said phone book;
if yes, displaying another phone number of said contact person for selecting;
receiving said selected phone number for the next redial and then dialing said phone number;
determining whether said phone call is connected successfully; and
if yes, carrying out said telephone conversation.

4. The smart redial method for mobile phones of claim 3 wherein, when said contact person only has one phone number in said phone book, said mobile phone enters into a regular redial procedure for directly dialing a phone number and redialing said phone number.

5. The smart redial method for mobile phones of claim 3, wherein said mobile phone continues receiving another phone number being selected and dials said phone number if a phone number is not connected successfully.

6. The smart redial method for mobile phones of claim 2, wherein said auto-redial control program further comprises the steps of:
checking whether said phone book has said contact person and said plurality of phone numbers of said contact person;
if yes, reading another phone number of said contact person from said phone book, and automatically dialing said number which has not been dialed yet;
determining whether said selected phone number is connected successfully;
if yes, carrying out said telephone conversation, and the ending said procedure.

7. The smart redial method for mobile phones of claim 6 wherein, when said contact person only has one phone number in said phone book, said mobile phone enters into a regular redial procedure for directly dialing a phone number and redialing said phone number.

8. The smart redial method for mobile phones of claim 6, wherein said mobile phone automatically dials another phone number that has not been dial yet, if a phone number being selected is not connected successfully.
